(19) United States
(12) Patent Application Publication
(10) Pub. No.: US 2026/0346860 A1
(43) Pub. Date: Nov. 5, 2026

(54) SYSTEMS AND METHODS FOR MANAGING A FOLLOWING DISTANCE OF A VEHICLE

(71) Applicant: GM GLOBAL TECHNOLOGY OPERATIONS LLC, Detroit, MI (US)

(72) Inventors: Alec M. Wuorinen, Columbus, OH (US); Matthew Edward Gilbert-Eyres, Rochester Hills, MI (US); Alexander Bower, Ann Arbor, MI (US); Ian Sherman, West Bloomfield, MI (US); Russell A. Patenaude, Macomb Township, MI (US)

(73) Assignee: GM GLOBAL TECHNOLOGY OPERATIONS LLC, Detroit, MI (US)

(21) Appl. No.: 19/196,974

(22) Filed: May 2, 2025

(51) Int. Cl. B60W 50/14; B60W 30/14; B60W 30/16; B60W 50/00

(52) U.S. Cl. CPC B60W 50/14; B60W 30/143; B60W 30/16; B60W 2050/0083; B60W 2050/146; B60W 2420/403; B60W 2420/408; B60W 2420/54; B60W 2520/10; B60W 2540/215; B60W 2552/05; B60W 2552/15; B60W 2552/30; B60W 2554/802; B60W 2555/20; B60W 2555/60

(57) ABSTRACT

In-front vehicle sensor data associated with an in-front vehicle is received from a sensor system of a vehicle. The in-front vehicle is disposed in front of the vehicle in a lane of a road. At least one in-front vehicle characteristic associated with the in-front vehicle is determined based on the in-front vehicle sensor data. An in-front vehicle characteristic based following distance of the vehicle with respect to the in-front vehicle is generated based on the at least one in-front vehicle characteristic. A final following distance is generated based at least in part on the in-front vehicle characteristic based following distance. A following distance notification including the final following distance is generated.

### INTRODUCTION

The technical field generally relates to vehicles, and more particularly relates to systems and methods for managing a following distance of a vehicle.

Following distances of a vehicle with respect to an in-front vehicle disposed in front of the vehicle on a lane of a road may vary depending on vehicle characteristics of the in-front vehicle, external environment conditions, a speed of the vehicle, and driver following distance preferences.

Accordingly, it is desirable to provide systems and methods for managing a following distance of a vehicle. Other desirable features and characteristics will become apparent from the subsequent detailed description and the appended claims, taken in conjunction with the accompanying drawings and the foregoing technical field and background.

### SUMMARY

A system for managing a following distance of a vehicle includes at least one processor and at least one memory communicatively coupled to the at least one processor. The at least one memory includes instructions that upon execution by the at least one processor, causes the at least one processor to: receive in-front vehicle sensor data associated with an in-front vehicle from a sensor system of the vehicle, the in-front vehicle being disposed in front of the vehicle in a lane of a road; determine at least one in-front vehicle characteristic associated with the in-front vehicle based on the in-front vehicle sensor data; generate an in-front vehicle characteristic based following distance of the vehicle with respect to the in-front vehicle based on the at least one in-front vehicle characteristic; generate a final following distance based at least in part on the in-front vehicle characteristic based following distance; and generate a following distance notification including the final following distance.

In at least one embodiment, the at least one memory further includes instructions that upon execution by the at least one processor, causes the at least one processor to: receive a crowdsourced following distance associated with the at least one characteristic of the in-front vehicle from a vehicle data collection center; and generate the final following distance based at least in part on the crowdsourced following distance.

In at least one embodiment, the at least one in-front vehicle characteristic includes a vehicle make, a vehicle model, a vehicle bumper sticker, a vehicle trailering status, vehicle movement, a vehicle condition, a vehicle speed, a vehicle propensity to kick up debris, and a vehicle type.

In at least one embodiment, the at least one memory further includes instructions that upon execution by the at least one processor, causes the at least one processor to: receive external environment data from at least one of the sensor system of the vehicle, a navigation system of the vehicle, and an external environment data source; generate at least one external environment condition based on the external environment data; generate an external environment condition based following distance of the vehicle with respect to the in-front vehicle based on the external environment condition; and generate the final following distance based at least in part on the external environment condition based following distance.

In at least one embodiment, the external environment data includes at least one of weather data, road condition data, global positioning system (GPS) data, vehicle routing data, vehicle dynamics data, road construction data, luggage strap data, external noise data, and external air characteristic data.

In at least one embodiment, the at least one memory further includes instructions that upon execution by the at least one processor, causes the at least one processor to: make a first determination regarding whether the external environment condition includes inclement weather; generate a first additional following distance based on the first determination; make a second determination regarding whether the external environment condition includes a poor road condition; generate a second additional following distance based on the second determination; make a third determination regarding whether the external environment condition includes at least one stop sign or at least one traffic light on a vehicle route; generate a third additional following distance based on the third determination; make a fourth determination regarding whether the external environment condition includes at least one curve or at least one hill on the vehicle route; generate a fourth additional following distance based on the fourth determination; make a fifth determination regarding whether the external environment condition includes a detected cannabis scent; generate a fifth additional following distance based on the fifth determination; make a sixth determination regarding whether the external environment condition includes a burned rubber scent; generate a sixth additional following distance based on the sixth determination; make a seventh determination regarding whether the external environment condition includes presence of road debris on the road; generate a seventh additional following distance based on the seventh determination; make an eighth determination regarding whether the external environment condition includes a loose luggage strap on the in-front vehicle; generate an eighth additional following distance based on the eighth determination; make a ninth determination regarding whether the external environment condition includes presence of gravel on the road; generate a ninth additional following distance based on the ninth determination; make a tenth determination regarding whether the external environment condition includes an obstacle blocking a view of the at least one traffic light from the vehicle; generate a tenth additional following distance based on the tenth determination; and generate the external environment condition based following distance based on a sum of the first, second, third, fourth, fifth, sixth, seventh, eighth, ninth, and tenth additional following distances.

In at least one embodiment, the at least one memory further includes instructions that upon execution by the at least one processor, causes the at least one processor to: receive a vehicle speed of the vehicle from the sensor system of the vehicle; generate a first speed-based following distance if the vehicle speed is greater than 75 miles per hour (mph); generate a second speed-based following distance if the vehicle speed is greater than 60 mph and less than 75 mph; generate a third speed-based following distance if the vehicle speed is greater than 45 mph and less than 60 mph; generate a fourth speed-based following distance if the vehicle speed is greater than 30 mph and less than 45 mph; generate a fifth speed-based following distance if the vehicle speed is less than 30 mph; and determine the final following distance at least in part on one of the first, second, third, fourth, and fifth speed-based following distances.

In at least one embodiment, the at least one memory further includes instructions that upon execution by the at least one processor, causes the at least one processor to: receive a user preference following distance via a user input device of the vehicle; and determine the final following distance based at least in part on the user preference following distance.

In at least one embodiment, the at least one memory further includes instructions that upon execution by the at least one processor, causes the at least one processor to: generate a final following distance implementation prompt for display on the display device of the vehicle; and issue a command to an automated driving system (ADS) of the vehicle to automatically implement the final following distance upon activation of the final following distance implementation prompt, wherein the ADS of the vehicle implements the final following distance in response to the command.

A method of managing a following distance of a vehicle includes: receiving in-front vehicle sensor data associated with an in-front vehicle from a sensor system of the vehicle, the in-front vehicle being disposed in front of the vehicle in a lane of a road; determining at least one in-front vehicle characteristic associated with the in-front vehicle based on the in-front vehicle sensor data; generating an in-front vehicle characteristic based following distance of the vehicle with respect to the in-front vehicle based on the at least one in-front vehicle characteristic; generating a final following distance based at least in part on the in-front vehicle characteristic based following distance; and generating a following distance notification including the final following distance for display on a display device of the vehicle.

In at least one embodiment, the method further includes: receiving a crowdsourced following distance associated with the at least one characteristic of the in-front vehicle from a vehicle data collection center; and generating the final following distance based at least in part on the crowdsourced following distance.

In at least one embodiment, the method further includes: receiving external environment data from at least one of the sensor system of the vehicle, a navigation system of the vehicle, and an external environment data source; generating at least one external environment condition based on the external environment data; generating an external environment condition based following distance of the vehicle with respect to the in-front vehicle based on the external environment condition; and generating the final following distance based at least in part on the external environment condition based following distance.

In at least one embodiment, the method further includes: making a first determination regarding whether the external environment condition includes inclement weather; generating a first additional following distance based on the first determination; making a second determination regarding whether the external environment condition includes a poor road condition; generating a second additional following distance based on the second determination; making a third determination regarding whether the external environment condition includes at least one stop sign or at least one traffic light on a vehicle route; generating a third additional following distance based on the third determination; making a fourth determination regarding whether the external environment condition includes at least one curve or at least one hill on the vehicle route; generating a fourth additional following distance based on the fourth determination; making a fifth determination regarding whether the external environment condition includes a detected cannabis scent; generating a fifth additional following distance based on the fifth determination; making a sixth determination regarding whether the external environment condition includes a burned rubber scent; generating a sixth additional following distance based on the sixth determination; making a seventh determination regarding whether the external environment condition includes presence of road debris on the road; generating a seventh additional following distance based on the seventh determination; making an eighth determination regarding whether the external environment condition includes a loose luggage strap on the in-front vehicle; generating an eighth additional following distance based on the eighth determination; making a ninth determination regarding whether the external environment condition includes presence of gravel on the road; generating a ninth additional following distance based on the ninth determination; making a tenth determination regarding whether the external environment condition includes an obstacle blocking a view of the at least one traffic light from the vehicle; generating a tenth additional following distance based on the tenth determination; and generating the external environment condition based following distance based on a sum of the first, second, third, fourth, fifth, sixth, seventh, eighth, ninth, and tenth additional following distances.

In at least one embodiment, the method further includes: receiving a vehicle speed of the vehicle from the sensor system of the vehicle; generating a first speed-based following distance if the vehicle speed is greater than 75 miles per hour (mph); generating a second speed-based following distance if the vehicle speed is greater than 60 mph and less than 75 mph; generating a third speed-based following distance if the vehicle speed is greater than 45 mph and less than 60 mph; generating a fourth speed-based following distance if the vehicle speed is greater than 30 mph and less than 45 mph; generating a fifth speed-based following distance if the vehicle speed is less than 30 mph; and determining the final following distance at least in part on one of the first, second, third, fourth, and fifth speed-based following distances.

In at least one embodiment, the method further includes: receiving a user preference following distance via a user input device of the vehicle; and determining the final following distance based at least in part on the user preference following distance.

In at least one embodiment, the method further includes: generating a final following distance implementation prompt for display on the display device of the vehicle; and issuing a command to an automated driving system (ADS) of the vehicle to automatically implement the final following distance upon activation of the final following distance implementation prompt, wherein the ADS of the vehicle implements the final following distance in response to the command.

A vehicle including a system for managing a following distance of the vehicle includes at least one processor and at least one memory communicatively coupled to the at least one processor. The at least one memory includes instructions that upon execution by the at least one processor, causes the at least one processor to: receive in-front vehicle sensor data associated with an in-front vehicle from a sensor system of the vehicle, the in-front vehicle being disposed in front of the vehicle in a lane of a road; determine at least one in-front vehicle characteristic associated with the in-front vehicle based on the in-front vehicle sensor data; generate an in-front vehicle characteristic based following distance of the vehicle with respect to the in-front vehicle based on the at least one in-front vehicle characteristic; generate a final following distance based at least in part on the in-front vehicle characteristic based following distance; generate a following distance notification including the final following distance for display on a display device of the vehicle; generate a final following distance implementation prompt for display on the display device of the vehicle; and issue a command to an automated driving system (ADS) of the vehicle to automatically implement the final following distance upon activation of the final following distance implementation prompt, wherein the ADS of the vehicle implements the final following distance in response to the command.

In at least one embodiment, the at least one memory further includes instructions that upon execution by the at least one processor, causes the at least one processor to: receive external environment data from at least one of the sensor system of the vehicle, a navigation system of the vehicle, and an external environment data source; generate at least one external environment condition based on the external environment data; generate an external environment condition based following distance of the vehicle with respect to the in-front vehicle based on the external environment condition; and generate the final following distance based at least in part on the external environment condition based following distance.

In at least one embodiment, the at least one memory further includes instructions that upon execution by the at least one processor, causes the at least one processor to: receive a vehicle speed of the vehicle from the sensor system of the vehicle; generate a first speed-based following distance if the vehicle speed is greater than 75 miles per hour (mph); generate a second speed-based following distance if the vehicle speed is greater than 60 mph and less than 75 mph; generate a third speed-based following distance if the vehicle speed is greater than 45 mph and less than 60 mph; generate a fourth speed-based following distance if the vehicle speed is greater than 30 mph and less than 45 mph; generate a fifth speed-based following distance if the vehicle speed is less than 30 mph; and determine the final following distance at least in part on one of the first, second, third, fourth, and fifth speed-based following distances.

In at least one embodiment, the at least one memory further includes instructions that upon execution by the at least one processor, causes the at least one processor to: receive a user preference following distance via a user input device of the vehicle; and determine the final following distance based at least in part on the user preference following distance.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle including a following distance management system in accordance with at least one embodiment;

FIG. 2 is a functional block diagram of a controller including a following distance management system in accordance with at least one embodiment; and

FIG. 3 is a flowchart representation of an exemplary method of managing a following distance of a vehicle in accordance with at least one embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

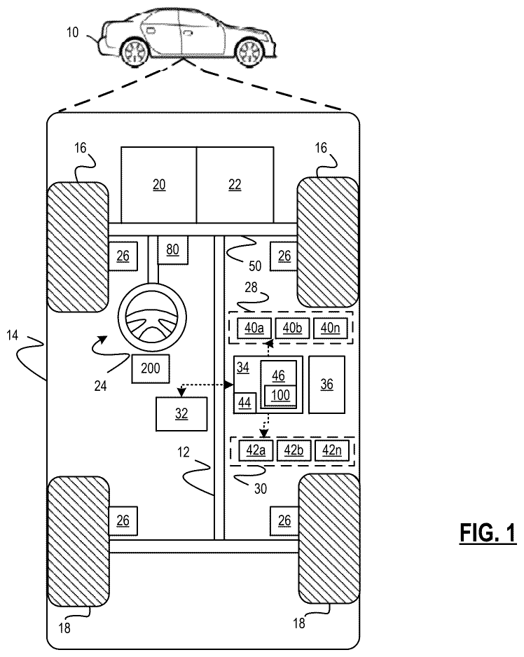

Referring to FIG. 1, a functional block diagram of a vehicle 10 including a following distance management system 100 in accordance with at least one embodiment is shown. The vehicle 10 generally includes a chassis 12, a body 14, front wheels 16, and rear wheels 18. While the vehicle 10 is depicted in the illustrated embodiment as a passenger car, the vehicle 10 may be other types of vehicles including trucks, sport utility vehicles (SUVs), and recreational vehicles (RVs).

In various embodiments, the body 14 is arranged on the chassis 12 and substantially encloses components of the vehicle 10. The body 14 and the chassis 12 may jointly form a frame. The wheels 16, 18 are each rotationally coupled to the chassis 12 near a respective corner of the body 14.

In various embodiments, the vehicle 10 is an autonomous or semi-autonomous vehicle that is automatically controlled to carry passengers and/or cargo from one place to another. For example, in an exemplary embodiment, the vehicle 10 is a so-called Level Two, Level Three, Level Four or Level Five automation system. Level two automation means the vehicle assists the driver in various driving tasks with driver supervision. Level three automation means the vehicle can take over all driving functions under certain circumstances. All major functions are automated, including braking, steering, and acceleration. At this level, the driver can fully disengage until the vehicle tells the driver otherwise. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the vehicle 10 generally includes a propulsion system 20 a transmission system 22, a steering system 24, a braking system 26, a sensor system 28, an actuator system 30, at least one data storage device 32, at least one controller 34, and a communication system 36. The controller 34 is configured to implement an automated driving system (ADS). The propulsion system 20 is configured to generate power to propel the vehicle. The propulsion system 20 includes an internal combustion engine (ICE). The propulsion system 20 may, in various embodiments, also include an electric machine such as a traction motor, a fuel cell propulsion system, and/or any other type of propulsion configuration. The transmission system 22 is configured to transmit power from the propulsion system 20 to the vehicle wheels 16, 18 according to selectable speed ratios. According to various embodiments, the transmission system 22 may include a step-ratio automatic transmission, a continuously-variable transmission, or other appropriate transmission. The braking system 26 is configured to provide braking torque to the vehicle wheels 16, 18. The braking system 26 may, in various embodiments, include friction brakes, brake by wire, a regenerative braking system such as an electric machine, and/or other appropriate braking systems.

The steering system 24 is configured to influence a position of the of the vehicle wheels 16. While depicted as including a steering wheel and steering column, for illustrative purposes, in some embodiments contemplated within the scope of the present disclosure, the steering system 24 may not include a steering wheel and/or steering column. The steering system 24 includes a steering column coupled to an axle 50 associated with the front wheels 16 through, for example, a rack and pinion or other mechanism (not shown). Alternatively, the steering system 24 may include a steer by wire system that includes actuators associated with each of the front wheels 16.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, a steering wheel sensor, and/or other sensors.

The vehicle dynamics sensors provide vehicle dynamics data including longitudinal speed, yaw rate, lateral acceleration, longitudinal acceleration, etc. The vehicle dynamics sensors may include wheel sensors that measure information pertaining to one or more wheels of the vehicle 10. In one embodiment, the wheel sensors comprise wheel speed sensors that are coupled to each of the wheels 16, 18 of the vehicle 10. Further, the vehicle dynamics sensors may include one or more accelerometers (provided as part of an Inertial Measurement Unit (IMU)) that measure information pertaining to an acceleration of the vehicle 10. In various embodiments, the accelerometers measure one or more acceleration values for the vehicle 10, including latitudinal and longitudinal acceleration and yaw rate. In at least one embodiment, the vehicle dynamic sensors provide vehicle location and vehicle movement data.

The actuator system 30 includes one or more actuator devices 42a-42n that control one or more vehicle features such as, but not limited to, one or more vehicle wheels 16, 18 the propulsion system 20, the transmission system 22, the steering system 24, and the braking system 26. In various embodiments, the vehicle features can further include interior and/or exterior vehicle features such as, but are not limited to, doors, a trunk, and cabin features such as air, music, lighting, etc. (not numbered).

The communication system 36 is configured to wirelessly communicate information to and from other entities 48, such as but not limited to, other vehicles (vehicle to vehicle, “V2V” communication,) infrastructure (vehicle to infrastructure “V2I” communication), remote systems, and/or personal devices. In an exemplary embodiment, the communication system 36 is a wireless communication system configured to communicate via a wireless local area network (WLAN) using IEEE 802.11 standards or by using cellular data communication. However, additional, or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in the ADS of the vehicle 10. In various embodiments, the data storage device 32 stores defined maps of the navigable environment. In various embodiments, the defined maps may be predefined by and obtained from a remote system. For example, the defined maps may be assembled by the remote system and communicated to the vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10. In at least one embodiment, the computer-readable storage device 46 is at least one memory configured to store the following distance management system 100.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10. In various embodiments, the controller(s) 34 are configured to implement ADS.

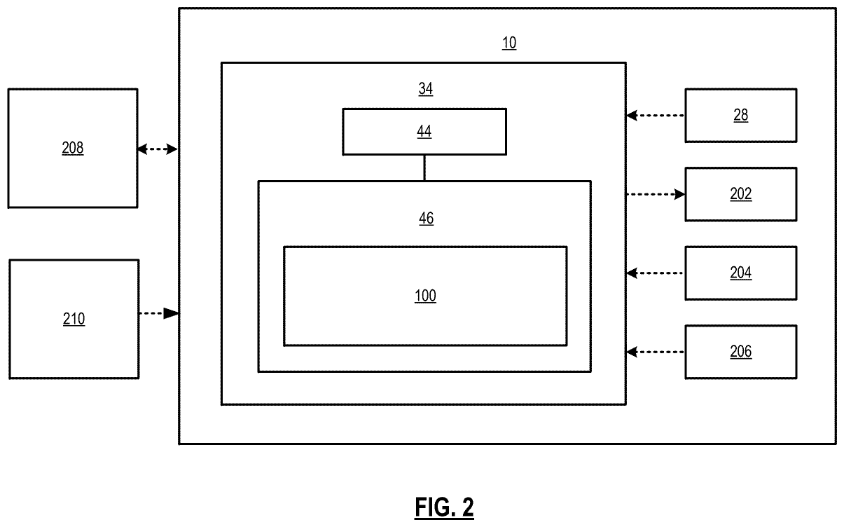

Referring to FIG. 2, a functional block diagram of a controller 34 including a following distance management system 100 in accordance with at least one embodiment is shown. The controller 34 includes at least one processor 44 and at least one memory 46. The at least one processor 44 is a programable device that includes one or more instructions stored in or associated with the at least one memory 46. The at least one memory 46 includes instructions that the at least one processor 44 is configured to execute. The at least one memory 46 includes an embodiment of the following distance management system 100.

The controller 34 is configured to be communicatively coupled to a sensor system 28, a display device 202, a user input device 204, and a navigation system 206 of the vehicle 10. The controller 34 is configured to be communicatively coupled to a vehicle data collection center 208 and an external environment data source 210. In at least one embodiment, the following distance management system 100 is disposed onboard a vehicle 10. In at least one embodiment, the following distance management system 100 is hosted by a cloud-based service. The controller 34 may include additional components that facilitate operation of the following distance management system 100. In at least one embodiment, the controller 34 may be referred to as the following distance management system 100. The operation of the following distance management system 100 will be described in greater detail below.

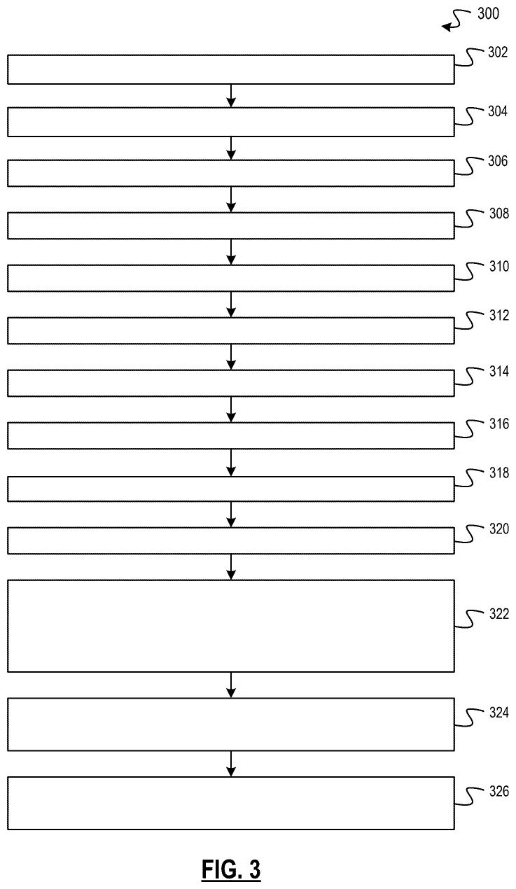

Referring to FIG. 3, a flowchart representation of an exemplary method 300 of managing a following distance of a vehicle 10 in accordance with at least one embodiment is shown. The method 300 will be described with reference to an exemplary implementation of an embodiment of a following distance management system 100. The vehicle 10 includes the following distance management system 100. As can be appreciated in light of the disclosure, the order of operation within the method 300 is not limited to the sequential execution as illustrated in FIG. 3 but may be performed in one or more varying orders as applicable and in accordance with the present disclosure.

The method 300 is initiated upon detection of an in-front vehicle by the vehicle 10 while the vehicle 10 is operating on a road. The in-front vehicle is disposed in front of the vehicle 10 in the same lane as the vehicle 10.

At 302, the following distance management system 100 receives a user preference following distance via a user input device 204. At 304, the following distance management system 100 receives in-front vehicle sensor data associated with an in-front vehicle from a sensor system 28 of the vehicle 10. The sensor system 28 includes one or more of light detection and ranging (LiDAR), radar, vehicle camera(s), air parameter detection, and microphone(s). An example of in-front vehicle sensor data is image data. The air parameter detection is configured to detect and identify, for example, a cannabis scent and a burned rubber scent in a collected air sample.

At 306, the following distance management system 100 determines one or more in-front vehicle characteristics of the in-front vehicle. Examples of in-front vehicle characteristics include, but are not limited to, a vehicle make, a vehicle model, a vehicle bumper sticker, a vehicle trailering status, vehicle movement, a vehicle condition, a vehicle speed, a vehicle propensity to kick up debris, and a vehicle type. An example of a vehicle bumper sticker is a “baby on board” sign. The vehicle trailering status indicates whether the in-front vehicle is attached to a trailer. An example of vehicle movement is erratic vehicle movement that may be indicative of erratic driver behavior. An example of a vehicle condition is a broken bumper. An in-front vehicle, such as for example a construction truck, may have an in-front vehicle characteristic of a vehicle propensity to kick up debris that may impact the vehicle 10. Examples of vehicle types, include but are not limited to an 18 wheeler truck and a motorcycle.

At 308, the following distance management system 100 generates an in-front vehicle characteristic based following distance based on the one or more in-front vehicle characteristics of the in-front vehicle. For example, when the in-front vehicle is a motorcycle, the in-front vehicle characteristic based following distance may be greater than when the vehicle is a sedan.

At 310, the following distance management system 100 receives crowdsourced following distance from a vehicle data collection center 208. In at least one embodiment, following distance management system 100 transmits the one more in-front vehicle characteristics to the vehicle data collection center 208. The vehicle data collection center 208 collects crowdsourced following distance data associated with different in-front vehicle characteristics from a plurality of different vehicles. The vehicle data collection center 208 generates a crowdsourced following distance based on the one more in-front vehicle characteristics received from the vehicle 10 and the crowdsourced following distance data associated with different in-front vehicle characteristics collected from the plurality of different vehicles. The vehicle data collection center 208 transmits the generated crowdsourced following distance to the following distance management system 100.

At 312, the following distance management system 100 receives external environment data from one or more of the sensor system 28, a navigation system 206 of the vehicle 10, and an external environment data source 210. Examples of external environment data includes, but are not limited to, weather data, road condition data, global positioning system (GPS) data, vehicle routing data, vehicle dynamics data, road construction data, luggage strap data, external noise data, and external air characteristic data.

At 314, the following distance management system 100 generates one or more external environment conditions based on the external environment data. Examples of external environment conditions include but are not limited to, inclement weather, poor road conditions, the vehicle route includes one or more stops signs and/or traffic lights, the vehicle route includes one or more curves or one or more hills, detected cannabis scent, detected burned rubber scent, presence of road debris on the road, a loose luggage strap, presence of gravel on the road, and an obstacle blocking a view of traffic lights from the vehicle 10.

At 316, the following distance management system 100 generates an external environment condition based following distance based on the one or more external environment conditions.

In at least one embodiment, the following distance management system 100 determines whether the one more external environment conditions includes inclement weather. If the following distance management system 100 determines that the one more external environment conditions includes inclement weather, the following distance management system 100 generates a first additional following distance associated with inclement weather.

The following distance management system 100 determines whether the one more external environment conditions includes poor road conditions. If the following distance management system 100 determines that the one more external environment conditions includes poor road conditions, the following distance management system 100 generates a second additional following distance associated with poor road conditions.

The following distance management system 100 determines whether the one more external environment conditions includes one or more stop signs and/or one or more traffic lights on a vehicle route of the vehicle 10. If the following distance management system 100 determines that the one more external environment conditions includes one or more stop signs and/or one or more traffic lights on the vehicle route of the vehicle 10, the following distance management system 100 generates a third additional following distance associated with the presence of the one or more stop signs and/or the one or more traffic lights on the vehicle route.

The following distance management system 100 determines whether the one more external environment conditions includes one or more curves and/or one or more hills on the vehicle route of the vehicle 10. If the following distance management system 100 determines that the one more external environment conditions includes one or more curves and/or one or more hills on the vehicle route of the vehicle 10, the following distance management system 100 generates a fourth additional following distance associated with the presence of the one or more curves and/or one or more hills on the vehicle route.

The following distance management system 100 determines whether the one more external environment conditions includes a detected cannabis scent. If the following distance management system 100 determines that the one more external environment conditions includes a detected cannabis scent, the following distance management system 100 generates a fifth additional following distance associated with the detected cannabis scent.

The following distance management system 100 determines whether the one more external environment conditions includes a detected burned rubber scent. If the following distance management system 100 determines that the one more external environment conditions includes a detected burned rubber scent, the following distance management system 100 generates a sixth additional following distance associated with the detected burned rubber scent.

The following distance management system 100 determines whether the one more external environment conditions includes presence of road debris on the road. If the following distance management system 100 determines that the one more external environment conditions includes presence of road debris on the road, the following distance management system 100 generates a seventh additional following distance associated with the presence of road debris on the road.

The following distance management system 100 determines whether the one more external environment conditions includes a loose luggage strap on the in-front vehicle. If the following distance management system 100 determines that the one more external environment conditions includes a loose luggage strap on the in-front vehicle, the following distance management system 100 generates an eighth additional following distance associated with the loose luggage strap on the in-front vehicle.

The following distance management system 100 determines whether the one more external environment conditions includes presence of gravel on the road. If the following distance management system 100 determines that the one more external environment conditions includes presence of gravel on the road, the following distance management system 100 generates a ninth additional following distance associated with the presence of gravel on the road.

The following distance management system 100 determines whether the one more external environment conditions includes an obstacle blocking a view of traffic lights from the vehicle 10. If the following distance management system 100 determines that the one more external environment conditions includes an obstacle blocking a view of traffic lights from the vehicle 10, the following distance management system 100 generates a tenth additional following distance associated with the obstacle blocking a view of traffic lights from the vehicle 10.

The following distance management system 100 generates the external environment condition based following distance as a sum of the first, second, third, fourth, fifth, sixth, seventh, eighth, ninth, and tenth additional following distances. In at least one embodiment, the first, second, third, fourth, fifth, sixth, seventh, eighth, ninth, and tenth additional following distances are pre-defined values that are stored at the following distance management system 100 in association with the external environment conditions detailed above.

At 318, the following distance management system 100 receives a vehicle speed of the vehicle 10 from the sensor system 28 of the vehicle 10. At 320, the following distance management system 100 generates a speed-based following distance based on the vehicle speed.

In at least one embodiment, the following distance management system 100 determines whether the vehicle speed is greater than 75 miles per hour (mph). If the following distance management system 100 determines that the vehicle speed is greater than 75 mph, the following distance management system 100 generates a first speed-based following distance.

The following distance management system 100 determines whether the vehicle speed is greater than 60 mph and less than 75 mph. If the following distance management system 100 determines that the vehicle speed is greater than 60 mph and less than 75 mph, the following distance management system 100 generates a second speed-based following distance.

The following distance management system 100 determines whether the vehicle speed is greater than 45 mph and less than 60 mph. If the following distance management system 100 determines that the vehicle speed is greater than 45 mph and less than 60 mph, the following distance management system 100 generates a third speed-based following distance.

The following distance management system 100 determines whether the vehicle speed is greater than 30 mph and less than 45 mph. If the following distance management system 100 determines that the vehicle speed is greater than 30 mph and less than 45 mph, the following distance management system 100 generates a fourth speed-based following distance.

The following distance management system 100 determines whether the vehicle speed is less than 30 mph. If the following distance management system 100 determines that the vehicle speed is less than 30 mph, the following distance management system 100 generates a fifth speed-based following distance.

The first speed-based following distance, the second speed-based following distance, the third speed-based following distance, the fourth speed-based following distance, and the fifth speed-based following distance have different values. The first speed-based following distance, the second speed-based following distance, the third speed-based following distance, the fourth speed-based following distance, and the fifth speed-based following distance are pre-defined values that are stored in association with the different vehicle speed ranges at the following distance management system 100.

At 322, the following distance management system 100 generates a final following distance based on the user preference following distance, the in-front vehicle characteristic based following distance, the crowdsourced following distance, the external environment condition based following distance, and the speed-based following distance. In at least one embodiment, the user preference following distance is used as a baseline following distance. The final following distance is always greater than the user preference following distance.

In at least one embodiment, the following distance management system 100 generates a weighted average of the in-front vehicle characteristic based following distance and the crowdsourced following distance. The following distance management system 100 generates the final following distance as a sum of the user preference following distance, the weighted average of the in-front vehicle characteristic based following distance and the crowdsourced following distance, the external environment condition based following distance, and the speed-based following distance.

At 324, the following distance management system 100 generates a following distance notification including the following distance notification and a final following distance implementation prompt on a display device 202 of the vehicle 10. In at least one embodiment, the following distance management system 100 generates the following distance notification as an audio notification or a haptic notification.

In at least one embodiment, the following distance management system 100 receives an actual following distance of the vehicle 10 with respect to the in-front vehicle from the sensor system 28 of the vehicle 10.

The following distance management system 100 determines whether the actual following distance is greater than or equal to the final following distance. If the following distance management system 100 determines that the actual following distance is greater than or equal to the final following distance, the following distance management system 100 generates a following distance notification indicating that no change in the following distance is recommended.

The following distance management system 100 determines whether the actual following distance is less than the final following distance. If the following distance management system 100 determines that the actual following distance is less than the final following distance, the following distance management system 100 compares a difference between the actual following distance and the final following distance to a following distance threshold.

If the following distance management system 100 determines that the difference between the actual following distance and the final following distance is greater than the following distance threshold, the following distance management system 100 generates a following distance notification to consider increasing the following distance of the vehicle 10 with respect to the in-front vehicle. The following distance management system 100 generates the final following distance implementation prompt for display on the display device 202 of the vehicle 10.

If the following distance management system 100 determines that the difference between the actual following distance and the final following distance is less than the following distance threshold, the following distance management system 100 generates a following distance notification to instruct the driver to increase the following distance of the vehicle 10 with respect to the in-front vehicle. The following distance management system 100 generates the final following distance implementation prompt for display on the display device 202 of the vehicle 10.

At 326, the following distance management system 100 issues a command to an ADS of the vehicle 10 to automatically implement the final following distance upon activation of the final following distance implementation prompt via the user input device 204 of the vehicle 10. The ADS maneuvers the vehicle 10 to implement the final following distance in response to the command.

In an example first use case, the following distance management system 100 identifies a vehicle type of an in-front vehicle as a logging truck. The following distance management system 100 requests a crowdsourced following distance associated with a logging truck from the vehicle data collection center 208 and receives the requested crowdsourced following distance from the vehicle data collection center 208. The following distance management system 100 generates a final following distance in accordance with the crowdsourced following distance. The following distance management system 100 determines that the actual following distance is less than the final following distance and that a difference between the actual following distance and the final following distance is greater than the following distance threshold. The following distance management system 100 generates a final following distance notification for display on a display device 202 of the vehicle 10 requesting that the driver consider increasing the following distance of the vehicle 10 with respect to the logging truck.

The following distance management system 100 generates the final following distance implementation prompt on the display device 202 of the vehicle 10. The following distance management system 100 issues a command to an ADS of the vehicle 10 to automatically implement the final following distance upon activation of the final following distance implementation prompt via the user input device 204 of the vehicle 10. The ADS maneuvers the vehicle 10 to implement the final following distance in response to the command.

In an example second use case, the following distance management system 100 determines that the movement of the in-front vehicle is erratic vehicle movement that may be indicative of erratic driver behavior. The following distance management system 100 generates an in-front vehicle characteristic based following distance based on the erratic vehicle movement. The following distance management system 100 generates a final following distance in accordance with in-front vehicle characteristic based following distance. The following distance management system 100 determines that the actual following distance is less than the final following distance and that a difference between the actual following distance and the final following distance is less than the following distance threshold. The following distance management system 100 generates a final following distance notification for display on a display device 202 instructing the driver to immediately increase the following distance of the vehicle 10 with respect to the in-front vehicle.

The following distance management system 100 generates the final following distance implementation prompt on the display device 202 of the vehicle 10. The following distance management system 100 issues a command to an ADS of the vehicle 10 to automatically implement the final following distance upon activation of the final following distance implementation prompt via the user input device 204 of the vehicle 10. The ADS maneuvers the vehicle 10 to implement the final following distance in response to the command.

In an example third use case, the following distance management system 100 identifies a vehicle type of an in-front vehicle as a motorcycle. The following distance management system 100 requests a crowdsourced following distance associated with a motorcycle from the vehicle data collection center 208 and receives the requested crowdsourced following distance from the vehicle data collection center 208. The following distance management system 100 generates a final following distance in accordance with the crowdsourced following distance. The following distance management system 100 determines that the actual following distance is greater than the final following distance. The following distance management system 100 generates a final following distance notification for display on a display device 202 of the vehicle 10 indicating that no change in following distance is recommended.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A system for managing a following distance of a vehicle, comprising:
at least one processor; and
at least one memory communicatively coupled to the at least one processor, the at least one memory comprising instructions that upon execution by the at least one processor, causes the at least one processor to:
receive in-front vehicle sensor data associated with an in-front vehicle from a sensor system of the vehicle, the in-front vehicle being disposed in front of the vehicle in a lane of a road;
determine at least one in-front vehicle characteristic associated with the in-front vehicle based on the in-front vehicle sensor data;
generate an in-front vehicle characteristic based following distance of the vehicle with respect to the in-front vehicle based on the at least one in-front vehicle characteristic;
generate a final following distance based at least in part on the in-front vehicle characteristic based following distance; and
generate a following distance notification including the final following distance.

2. The system of claim 1, wherein the at least one memory further comprises instructions that upon execution by the at least one processor, causes the at least one processor to:
receive a crowdsourced following distance associated with the at least one characteristic of the in-front vehicle from a vehicle data collection center; and
generate the final following distance based at least in part on the crowdsourced following distance.

3. The system of claim 1, wherein the at least one in-front vehicle characteristic comprises a vehicle make, a vehicle model, a vehicle bumper sticker, a vehicle trailering status, vehicle movement, a vehicle condition, a vehicle speed, a vehicle propensity to kick up debris, and a vehicle type.

4. The system of claim 1, wherein the at least one memory further comprises instructions that upon execution by the at least one processor, causes the at least one processor to:
receive external environment data from at least one of the sensor system of the vehicle, a navigation system of the vehicle, and an external environment data source;
generate at least one external environment condition based on the external environment data;
generate an external environment condition based following distance of the vehicle with respect to the in-front vehicle based on the external environment condition; and
generate the final following distance based at least in part on the external environment condition based following distance.

5. The system of claim 4, wherein the external environment data comprises at least one of weather data, road condition data, global positioning system (GPS) data, vehicle routing data, vehicle dynamics data, road construction data, luggage strap data, external noise data, and external air characteristic data.

6. The system of claim 4, wherein the at least one memory further comprises instructions that upon execution by the at least one processor, causes the at least one processor to:
make a first determination regarding whether the external environment condition comprises inclement weather;
generate a first additional following distance based on the first determination;
make a second determination regarding whether the external environment condition comprises a poor road condition;
generate a second additional following distance based on the second determination;
make a third determination regarding whether the external environment condition comprises at least one stop sign or at least one traffic light on a vehicle route;
generate a third additional following distance based on the third determination;
make a fourth determination regarding whether the external environment condition comprises at least one curve or at least one hill on the vehicle route;
generate a fourth additional following distance based on the fourth determination;
make a fifth determination regarding whether the external environment condition comprises a detected cannabis scent;
generate a fifth additional following distance based on the fifth determination;
make a sixth determination regarding whether the external environment condition comprises a burned rubber scent;
generate a sixth additional following distance based on the sixth determination;
make a seventh determination regarding whether the external environment condition comprises presence of road debris on the road;
generate a seventh additional following distance based on the seventh determination;
make an eighth determination regarding whether the external environment condition comprises a loose luggage strap on the in-front vehicle;
generate an eighth additional following distance based on the eighth determination;
make a ninth determination regarding whether the external environment condition comprises presence of gravel on the road;
generate a ninth additional following distance based on the ninth determination;
make a tenth determination regarding whether the external environment condition comprises an obstacle blocking a view of the at least one traffic light from the vehicle;
generate a tenth additional following distance based on the tenth determination; and
generate the external environment condition based following distance based on a sum of the first, second, third, fourth, fifth, sixth, seventh, eighth, ninth, and tenth additional following distances.

7. The system of claim 1, wherein the at least one memory further comprises instructions that upon execution by the at least one processor, causes the at least one processor to:
receive a vehicle speed of the vehicle from the sensor system of the vehicle;
generate a first speed-based following distance if the vehicle speed is greater than 75 miles per hour (mph);
generate a second speed-based following distance if the vehicle speed is greater than 60 mph and less than 75 mph;
generate a third speed-based following distance if the vehicle speed is greater than 45 mph and less than 60 mph;
generate a fourth speed-based following distance if the vehicle speed is greater than 30 mph and less than 45 mph;
generate a fifth speed-based following distance if the vehicle speed is less than 30 mph; and
determine the final following distance at least in part on one of the first, second, third, fourth, and fifth speed-based following distances.

8. The system of claim 1, wherein the at least one memory further comprises instructions that upon execution by the at least one processor, causes the at least one processor to:
receive a user preference following distance via a user input device of the vehicle; and
determine the final following distance based at least in part on the user preference following distance.

9. The system of claim 1, wherein the at least one memory further comprises instructions that upon execution by the at least one processor, causes the at least one processor to:
generate a final following distance implementation prompt for display on the display device of the vehicle; and
issue a command to an automated driving system (ADS) of the vehicle to automatically implement the final following distance upon activation of the final following distance implementation prompt, wherein the ADS of the vehicle implements the final following distance in response to the command.

10. A method of managing a following distance of a vehicle comprising:
receiving in-front vehicle sensor data associated with an in-front vehicle from a sensor system of the vehicle, the in-front vehicle being disposed in front of the vehicle in a lane of a road;
determining at least one in-front vehicle characteristic associated with the in-front vehicle based on the in-front vehicle sensor data;
generating an in-front vehicle characteristic based following distance of the vehicle with respect to the in-front vehicle based on the at least one in-front vehicle characteristic;
generating a final following distance based at least in part on the in-front vehicle characteristic based following distance; and
generating a following distance notification including the final following distance for display on a display device of the vehicle.

11. The method of claim 10, further comprising:
receiving a crowdsourced following distance associated with the at least one characteristic of the in-front vehicle from a vehicle data collection center; and
generating the final following distance based at least in part on the crowdsourced following distance.

12. The method of claim 10, further comprising:
receiving external environment data from at least one of the sensor system of the vehicle, a navigation system of the vehicle, and an external environment data source;
generating at least one external environment condition based on the external environment data;
generating an external environment condition based following distance of the vehicle with respect to the in-front vehicle based on the external environment condition; and
generating the final following distance based at least in part on the external environment condition based following distance.

13. The method of claim 12, further comprising:
making a first determination regarding whether the external environment condition comprises inclement weather;
generating a first additional following distance based on the first determination;
making a second determination regarding whether the external environment condition comprises a poor road condition;
generating a second additional following distance based on the second determination;
making a third determination regarding whether the external environment condition comprises at least one stop sign or at least one traffic light on a vehicle route;
generating a third additional following distance based on the third determination;
making a fourth determination regarding whether the external environment condition comprises at least one curve or at least one hill on the vehicle route;
generating a fourth additional following distance based on the fourth determination;
making a fifth determination regarding whether the external environment condition comprises a detected cannabis scent;
generating a fifth additional following distance based on the fifth determination;
making a sixth determination regarding whether the external environment condition comprises a burned rubber scent;
generating a sixth additional following distance based on the sixth determination;
making a seventh determination regarding whether the external environment condition comprises presence of road debris on the road;
generating a seventh additional following distance based on the seventh determination;
making an eighth determination regarding whether the external environment condition comprises a loose luggage strap on the in-front vehicle;
generating an eighth additional following distance based on the eighth determination;
making a ninth determination regarding whether the external environment condition comprises presence of gravel on the road;
generating a ninth additional following distance based on the ninth determination;
making a tenth determination regarding whether the external environment condition comprises an obstacle blocking a view of the at least one traffic light from the vehicle;
generating a tenth additional following distance based on the tenth determination; and
generating the external environment condition based following distance based on a sum of the first, second, third, fourth, fifth, sixth, seventh, eighth, ninth, and tenth additional following distances.

14. The method of claim 10, further comprising:
receiving a vehicle speed of the vehicle from the sensor system of the vehicle;
generating a first speed-based following distance if the vehicle speed is greater than 75 miles per hour (mph);
generating a second speed-based following distance if the vehicle speed is greater than 60 mph and less than 75 mph;
generating a third speed-based following distance if the vehicle speed is greater than 45 mph and less than 60 mph;
generating a fourth speed-based following distance if the vehicle speed is greater than 30 mph and less than 45 mph;
generating a fifth speed-based following distance if the vehicle speed is less than 30 mph; and
determining the final following distance at least in part on one of the first, second, third, fourth, and fifth speed-based following distances.

15. The method of claim 10, further comprising:
receiving a user preference following distance via a user input device of the vehicle; and
determining the final following distance based at least in part on the user preference following distance.

16. The method of claim 10, further comprising:
generating a final following distance implementation prompt for display on the display device of the vehicle; and
issuing a command to an automated driving system (ADS) of the vehicle to automatically implement the final following distance upon activation of the final following distance implementation prompt, wherein the ADS of the vehicle implements the final following distance in response to the command.

17. A vehicle including a system for managing a following distance of the vehicle comprising:
at least one processor; and
at least one memory communicatively coupled to the at least one processor, the at least one memory comprising instructions that upon execution by the at least one processor, causes the at least one processor to:
receive in-front vehicle sensor data associated with an in-front vehicle from a sensor system of the vehicle, the in-front vehicle being disposed in front of the vehicle in a lane of a road;
determine at least one in-front vehicle characteristic associated with the in-front vehicle based on the in-front vehicle sensor data;
generate an in-front vehicle characteristic based following distance of the vehicle with respect to the in-front vehicle based on the at least one in-front vehicle characteristic;
generate a final following distance based at least in part on the in-front vehicle characteristic based following distance;
generate a following distance notification including the final following distance for display on a display device of the vehicle;
generate a final following distance implementation prompt for display on the display device of the vehicle; and
issue a command to an automated driving system (ADS) of the vehicle to automatically implement the final following distance upon activation of the final following distance implementation prompt, wherein the ADS of the vehicle implements the final following distance in response to the command.

18. The vehicle of claim 17, wherein the at least one memory further comprises instructions that upon execution by the at least one processor, causes the at least one processor to:
receive external environment data from at least one of the sensor system of the vehicle, a navigation system of the vehicle, and an external environment data source;
generate at least one external environment condition based on the external environment data;
generate an external environment condition based following distance of the vehicle with respect to the in-front vehicle based on the external environment condition; and
generate the final following distance based at least in part on the external environment condition based following distance.

19. The vehicle of claim 17, wherein the at least one memory further comprises instructions that upon execution by the at least one processor, causes the at least one processor to:
receive a vehicle speed of the vehicle from the sensor system of the vehicle;
generate a first speed-based following distance if the vehicle speed is greater than 75 miles per hour (mph);
generate a second speed-based following distance if the vehicle speed is greater than 60 mph and less than 75 mph;
generate a third speed-based following distance if the vehicle speed is greater than 45 mph and less than 60 mph;
generate a fourth speed-based following distance if the vehicle speed is greater than 30 mph and less than 45 mph;
generate a fifth speed-based following distance if the vehicle speed is less than 30 mph; and
determine the final following distance at least in part on one of the first, second, third, fourth, and fifth speed-based following distances.

20. The vehicle of claim 17, wherein the at least one memory further comprises instructions that upon execution by the at least one processor, causes the at least one processor to:
receive a user preference following distance via a user input device of the vehicle; and
determine the final following distance based at least in part on the user preference following distance.
